(19) United States
(12) Patent Application Publication
(10) Pub. No.: US 2012/0301084 A1
(43) Pub. Date: Nov. 29, 2012

(54) CABLE ASSEMBLIES HAVING LABELS AND METHODS FOR MAKING THE SAME

(76) Inventors: David R. Kozischek, Hickory, NC (US); Annie J. Propst, Hickory, NC (US)

(21) Appl. No.: 13/117,454

(22) Filed: May 27, 2011

(51) Int. Cl. G02B 6/36; B23P 17/04

(52) U.S. Cl. 385/76; 29/428

(57) ABSTRACT

Cable assemblies having a connector, a cable and a label along with methods for making the same are disclosed. The label is attached to the cable assembly near the connector and wraps about a portion of the cable in the stored position and is extendable from the cable in an elongated position. Consequently, the label provides the craft with a suitable length for marking information, but the label moves to convenient storage position when not in use.

### BACKGROUND

The disclosure is directed to cable assemblies having labels for identification of the assembly. More specifically, the disclosure is directed to cable assemblies having a label that wraps about a portion of the cable along with methods for making the same.

Optical fiber is increasingly being used for a variety of applications, including but not limited to broadband voice, video, and data transmission. Optical networks typically include patch panels (i.e., arrays of connectors) connected by jumper cable assemblies. The patch panels provide a common location where moves, adds, or changes to connectivity of the channels of the optical network can be made by changing the ports for the jumper cable assemblies. Likewise, testing and troubleshooting may also occur that the patch panel. The patch panels typically have a relatively large and dense array of optical connections and determining which port a particular jumper cable is optically attached with can be difficult and/or time consuming for the craft. Consequently, the craft often labels the jumper cables at the patch panels so if troubleshooting or moves, adds, changes are required it is easy for the craft to identify the desired jumper cable.

By way of example, FIG. 1 depicts a prior art cable assembly including a label for aiding the craft when trying to identify a specific link in the network. Specifically, the cable assembly includes a fiber optic connector 10 attached to a fiber optic cable 12 with a label 14 adhesively attached to fiber optic cable 12. As shown, label 14 is a flag label that is attached to the cable 12 and allows the craft to read the same when the cable assembly is installed in the patch panel. However, the flag label of FIG. 1 has drawbacks such as adding bulk and/or obstructions at a point where the small diameter of the cable is critical for cable management especially in high-density patch panels. Moreover, it is relatively easy for the flag label to be inadvertently torn, ripped or otherwise removed from the cable assembly.

Other types of labels have been used that overcome the drawbacks of flag labels; however, these other labels also have drawbacks. Illustratively, FIG. 2 depicts another prior art cable assembly with different type of label. Specifically, the cable assembly includes label 14 which is configured as a wrap-around label. In other words, label 14 of FIG. 2 is adhesively attached to and wrapped about fiber optic cable 12. Generally speaking, the wrap-around label 14 solves some of the issues of flag label of FIG. 1, but the wrap-around label 14 has its own drawbacks. For instance, wrap-around label 14 does not add bulk and/or the obstructions like the flag label of FIG. 1, but there typically is not enough marking area on the label for detailed labeling. Further, the craft may find it difficult to read the label when the cable assembly is secured to the patch panel. Consequently, the craft may have to remove the connector 10 of the cable assembly from the patch panel and rotate the cable assembly to read the wrap-around label 14.

Still other labels for cable assemblies exist such as bands that snap about the cable, but these labels can migrate along the length of the cable and may be difficult to quickly locate in a densely-packed patch panel. Consequently, there is an unresolved need for easy and efficient labeling for connectors such as electrical or fiber optic connectors and their related cable assemblies.

### SUMMARY

The disclosure is directed to cable assemblies having a connector, a cable and a label along with methods for making the same. The label is located near the connector and wraps about a portion of the cable in the stored position and is extendable from the cable in an elongated position. Thus, the label provides the craft with adequate length of label for marking information, while providing a convenient storage position for the label when not extended. Further, the storage positions protects the label from damage while also maintaining a relatively small footprint for the connector.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is perspective view of a prior art flag label attached to a cable assembly that is connected at a patch panel;

FIG. 2 is a top view of a prior art wrap-around label attached to a cable assembly;

FIG. 3 is a schematic representation of a cable assembly having a connector with a label in the stored position; and

FIG. 4 is a schematic representation of the cable assembly of FIG. 3 with the label in the extended position so the craft can read the information on the label.

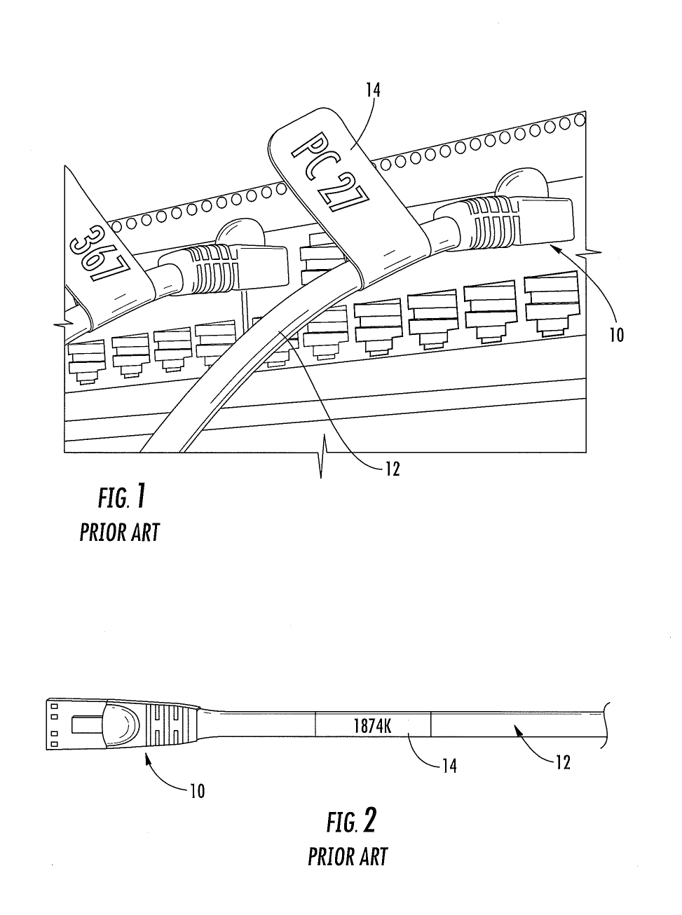

### DETAILED DESCRIPTION OF THE PREFERRED EMBODIMENTS

Reference will now be made in detail to the preferred embodiments of the disclosure, examples of which are illustrated in the accompanying drawings. Whenever possible, like reference numbers will be used to refer to like components or parts.

The connectors and/or cable assemblies described herein are suitable for making optical and/or electrical connections for a variety of devices. The concepts of the disclosure advantageously allow the simple, quick, and economical marking for connectors and/or cable assemblies while also providing a suitable surface for identifying the link by the craft. Reference will now be made in detail to the preferred embodiments, examples of which are illustrated in the accompanying drawings. Whenever possible, like reference numbers will be used to refer to like components or parts.

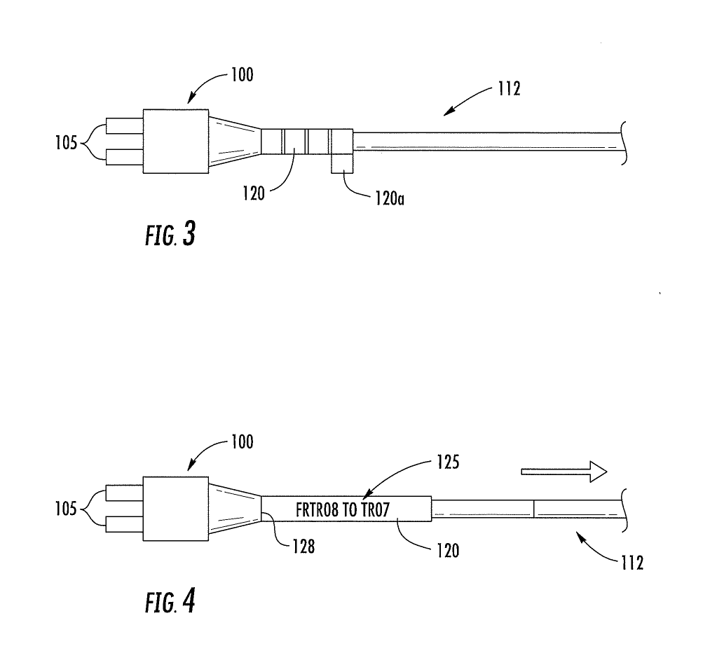

FIGS. 3 and 4 are schematic representations depicting a cable assembly having a connector 100, a cable 112, and a label 120. Specifically, FIG. 3 shows label 120 of connector 100 in a stored position and FIG. 4 shows label 120 of connector 100 in an elongated position (i.e., extended position). More specifically, label 120 wraps about a portion of cable 112 defining a label storage area (not numbered) about the cable 112. The label 120 is extendable from the cable 112 when desired so the craft can read the marking information on the label 120 for the link. One end of label 120 is optionally attached to a portion of the cable assembly near the connector at attachment 128; however, in other embodiments the label may be attached but move freely along the length of the cable assembly. Because label 120 has a stored position when not needed it damage and/or accidental removal of the label 120 is inhibited. Consequently, the connectors and components of the disclosure advantageous provide a label with a suitable length that is easy to read and store while not being overly obtrusive or creating a connector that is too large for densely packed patch panels.

The concepts disclosed herein may be used with any suitable connector and/or any suitable connector component. By way of example, the connector may include electrical conductors such as copper traces, pins, etc., optical waveguides such as optical fiber, or hybrid connectors having both electrical and optical pathways. Illustratively, a conductor pathway 105 may be an electrical pin or a ferrule for an optical fiber, which is mated to a complimentary structure to form a communication connection. Further, the connector 100 may have a single communication pathway or configured with multiple communication pathways. By way of example, a connector may have a single conductor pathway or a multi-conductor pathway. For instance, a fiber optic connector may be a single-fiber connector or a multi-fiber connector as known in the art.

Label 120 may be attached on any suitable component(s) of the cable assembly such as loosely disposed about the cable, attached to a component, or configured so it can be removed from the cable assembly and attached as desired such as at an attachment 128 of label 120. By way of example, a suitable component for attachment 128 of label 120 may include a housing, a boot, a clip, the cable or other suitable component. For instance, a portion of label 120 may be molded into a portion of the housing, the boot, or the clip for a more permanent attachment 128 of label 120. In other embodiments, attachment 128 is configured in a removable fashion so the craft can remove label 120 for marking (or replacing) the label and then re-attach the label 120 to the cable assembly. As explanatory examples, label 120 may have an attachment 128 such as a snap-fit button, a small anchor on an end of the label with a suitable shape that fits into a complimentary groove on a component of the cable assembly, or other suitable structure for a removable attachment 128.

Label 120 may also include a shape memory characteristic for aiding in the wrapping of the label about a portion of the cable when in the stored position. For instance, label 120 may be wrapped about the cable at least twice in the stored position such as depicted in FIG. 3, thereby providing an adequate length of the label for marking by the craft. Label 120 may be formed using any suitable material(s) such as a polymer, metallic or composite material. Moreover, the shape memory characteristic is also useful in a retro-fit application for labeling existing cable assemblies. Simply stated, the label 128 may wrap about the cable 112 of the cable assembly so it can be added to any suitably sized cable assembly. The shape memory characteristic for label 120 can be induced using any suitable material and/or shape for creating the spiral wrap memory. Further there are several different ways for creating a shape memory characteristic.

In one embodiment, the label is simply formed from a suitably shaped polymer with the spiral shape and the craft has to pull the spiral wrap out of the label 120 for extending and reading the same. Then, when the pulling force on the label 120 is released it returns to its relaxed state of a spiral wrap shape (i.e., the shape memory returns the label to a spiral wrap with no force applied). Moreover, at least one surface of label 120 has a marking surface (not numbered) as shown in FIG. 4 and the marking surface is typically oriented to face outward so it can be read when on the cable assembly. In other embodiments, label 120 may have the marking surface on both sides of the label 120.

Other variations for creating the shape memory are also possible. For instance, label 120 may be a polymer, metallic or composite material that may have a suitable curve induced in its cross-sectional shape when the label is in the extended (i.e., straight) position that aids in holding the extended position of the label 120 for the craft. Then, when the curve in the cross-section is pushed out of the label 120 the shape memory returns the label 120 to its wrapped shape.

Label 120 may optionally include a pull tab 120a that protrudes when the label is in the stored position such as shown in FIG. 3. Pull tab 120a allows the craft to pull and/or unwind the label 120 from the cable assembly as represented by the arrow in FIG. 4. Connector 100 may also include other known structures such as a latching mechanism and/or other desired features depending on the style of connector being used. Additionally, a cable assembly can include one or more labels as desired.

Methods for making the cable assembly are also disclosed. For instance, methods for making the cable assembly include the steps of providing a cable assembly having a connector and a cable, providing a label having a shape memory, and attaching a portion of the label to the cable assembly. Methods can also include other steps for making cable assemblies such as forming a marking indicia on the label or providing a fiber optic cable for the cable assembly.

Although the disclosure has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the present invention without departing from the spirit and scope of the same. Thus, it is intended that the present invention cover the modifications and variations of this invention provided they come within the scope of the appended claims and their equivalents.

We claim:

1. A cable assembly, comprising:
a connector;
a cable attached to the connector; and
a label near the connector of the cable assembly, wherein the label wraps about a portion of the cable in a stored position and is extendable from the cable in an elongated position.

2. The cable assembly of claim 1, wherein the label has a shape memory for returning the label from the elongated position to the stored position.

3. The cable assembly of claim 1, the label having a marking surface.

4. The cable assembly of claim 1, the label being wrapped about the cable at least twice in the stored position.

5. The cable assembly of claim 1, wherein the label has a pull tab that protrudes from the cable when the label is in the stored position.

6. The cable assembly of claim 1, the connector selected from the group consisting of a single conductor pathway or a multi conductor pathway.

7. The cable assembly of claim 1, the label including a polymer, metallic or composite material.

8. The cable assembly of claim 1, further including a plurality of labels.

9. A fiber optic cable assembly, comprising:
a fiber optic connector;
a fiber optic cable attached to the fiber optic connector; and
a label near the fiber optic connector, wherein the label wraps about a portion of the fiber optic cable in a stored position and is extendable from the fiber optic cable in an elongated position.

10. The fiber optic cable assembly of claim 9, wherein the label has a shape memory for returning the label from the elongated position to the stored position.

11. The fiber optic cable assembly of claim 9, the label having a marking surface.

12. The fiber optic cable assembly of claim 9, the label being wrapped about the fiber optic cable at least twice in the stored position.

13. The fiber optic cable assembly of claim 9, wherein the label has a pull tab that protrudes from the fiber optic cable when the label is in the stored position.

14. The fiber optic cable assembly of claim 9, the fiber optic connector selected from the group consisting of a single-fiber connector or a multi-fiber connector.

15. The fiber optic cable assembly of claim 9, the label including a polymer, metallic, or composite material.

16. The fiber optic cable assembly of claim 9, further including a plurality of labels.

17. A method of making a cable assembly, comprising the steps of:
providing a cable assembly having a connector and a cable;
providing a label having a shape memory; and
attaching a portion of the label to the cable assembly.

18. The method of claim 17, further including the step of forming a marking indicia on the label.

19. The method of claim 17, wherein the cable assembly is a fiber optic cable assembly.
